(19) United States
(12) Patent Application Publication
(10) Pub. No.: US 2026/0048719 A1
(43) Pub. Date: Feb. 19, 2026

(54) VEHICLE WASHER FLUID MANAGEMENT SYSTEM

(71) Applicant: FORD GLOBAL TECHNOLOGIES, LLC, Dearborn, MI (US)

(72) Inventors: Mark George Vojtisek, Royal Oak, MI (US); Bregt Ectors, Ann Arbor, MI (US); Jacob Michael Haspiel, Ann Arbor, MI (US)

(21) Appl. No.: 18/808,238

(22) Filed: Aug. 19, 2024

(51) Int. Cl. B60S 1/50; B60S 1/48

(52) U.S. Cl. CPC B60S 1/50; B60S 1/481

(57) ABSTRACT

A device may include a washer fluid mixing tank within a compartment of a vehicle. A device may include a concentrate container that is outside the compartment, the concentrate container configured to hold a supply of washer concentrate fluid. A device may include a conduit that fluidly couples the concentrate container to the washer fluid mixing tank such that washer concentrate fluid held in the concentrate container can flow to the washer fluid mixing tank.

### TECHNICAL FIELD

This disclosure relates generally to managing washer fluid for a vehicle.

### BACKGROUND

Vehicle windshields can become dirty due to various environmental factors, such as dust, dirt, bugs, and other debris encountered during driving. Vehicles are often equipped with windshield washer systems to clean the windshield.

### SUMMARY

In some aspects, the techniques described herein relate to a vehicle washer fluid management system, including: a washer fluid mixing tank within a compartment of a vehicle; a concentrate container that is outside the compartment, the concentrate container configured to hold a supply of washer concentrate fluid; and a conduit that fluidly couples the concentrate container to the washer fluid mixing tank such that washer concentrate fluid held in the concentrate container can flow to the washer fluid mixing tank.

In some aspects, the techniques described herein relate to a vehicle washer fluid management system, wherein the washer fluid mixing tank is configured to receive a flow of collected fluid from a windshield of the vehicle.

In some aspects, the techniques described herein relate to a vehicle washer fluid management system, further including a fluid level sensor that measures an amount of collected fluid within the washer fluid mixing tank.

In some aspects, the techniques described herein relate to a vehicle washer fluid management system, further including a valve between the windshield and the washer fluid mixing tank, the valve configured to block the flow of collected fluid from the windshield in response to the fluid level sensor determining that the amount of collected fluid within the washer fluid mixing tank is above a predetermined threshold.

In some aspects, the techniques described herein relate to a vehicle washer fluid management system, wherein the valve is configured to block the flow of collected fluid from the windshield when the concentrate container is empty.

In some aspects, the techniques described herein relate to a vehicle washer fluid management system, wherein an amount of washer concentrate fluid that flows to the washer fluid mixing tank is adjusted based on the amount of collected fluid received within the washer fluid mixing tank.

In some aspects, the techniques described herein relate to a vehicle washer fluid management system, further including a filter configured to filter the flow of collected fluid from the windshield before the collected fluid is received within the washer fluid mixing tank.

In some aspects, the techniques described herein relate to a vehicle washer fluid management system, further including a flow sensor connected to the conduit and configured to measure an amount of washer concentrate fluid that flows to the washer fluid mixing tank.

In some aspects, the techniques described herein relate to a vehicle washer fluid management system, wherein the compartment is an engine compartment.

In some aspects, the techniques described herein relate to a vehicle washer fluid management system, wherein the concentrate container is within a passenger compartment of the vehicle.

In some aspects, the techniques described herein relate to a vehicle washer fluid management system, wherein the concentrate container is accessible from within a glovebox.

In some aspects, the techniques described herein relate to a vehicle washer fluid management system, wherein the concentrate container is disposed adjacent to a charger port.

In some aspects, the techniques described herein relate to a vehicle washer fluid management system, wherein the concentrate container is disposed adjacent to a leaf screen of the vehicle.

In some aspects, the techniques described herein relate to a vehicle washer fluid management method, including: receiving collected fluid in a washer fluid mixing tank within a compartment of a vehicle; and directing washer concentrate fluid from a concentrate container that is outside of the compartment to the washer fluid mixing tank to allow the collected fluid and the washer concentrate fluid to mix within the washer fluid mixing tank, the concentrate container fluidly coupled to the washer fluid mixing tank through a conduit.

In some aspects, the techniques described herein relate to a method, wherein the collected fluid is collected from a windshield of the vehicle.

In some aspects, the techniques described herein relate to a method, further including measuring an amount of collected fluid received within the washer fluid mixing tank before directing the washer concentrate fluid to the washer fluid mixing tank.

In some aspects, the techniques described herein relate to a method, further including blocking the collected fluid from being received in the washer fluid mixing tank in response to determining that the amount of collected fluid within the washer fluid mixing tank is above a predetermined threshold.

In some aspects, the techniques described herein relate to a method, further including blocking the collected fluid from being received in the washer fluid mixing tank in response to determining that the concentrate container is empty.

In some aspects, the techniques described herein relate to a method, further including adjusting an amount of washer concentrate fluid that is directed into the washer fluid mixing tank based on the amount of collected fluid received within the washer fluid mixing tank.

In some aspects, the techniques described herein relate to a method, wherein a ratio of collected fluid and washer concentrate fluid within the washer fluid mixing tank is controlled by a user, weather, exterior temperatures, or any combination thereof.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates a washer fluid management system according to an exemplary aspect of the present disclosure.

FIG. 2 illustrates a perspective view of a concentrate container of the washer fluid management system of FIG. 1 within a passenger compartment of a vehicle.

FIG. 3 is a section view of the concentrate container of FIGS. 1 and 2.

### DETAILED DESCRIPTION

This disclosure relates generally to a washer fluid management system for cleaning a vehicle windshield. The washer fluid management system can collect fluid, such as rainwater, and mix the collected fluid with a washer fluid concentrate. The washer fluid management system can maintain an appropriate ratio of windshield washer fluid to collect fluid. These and other features are discussed in greater detail in the following paragraphs of this detailed description.

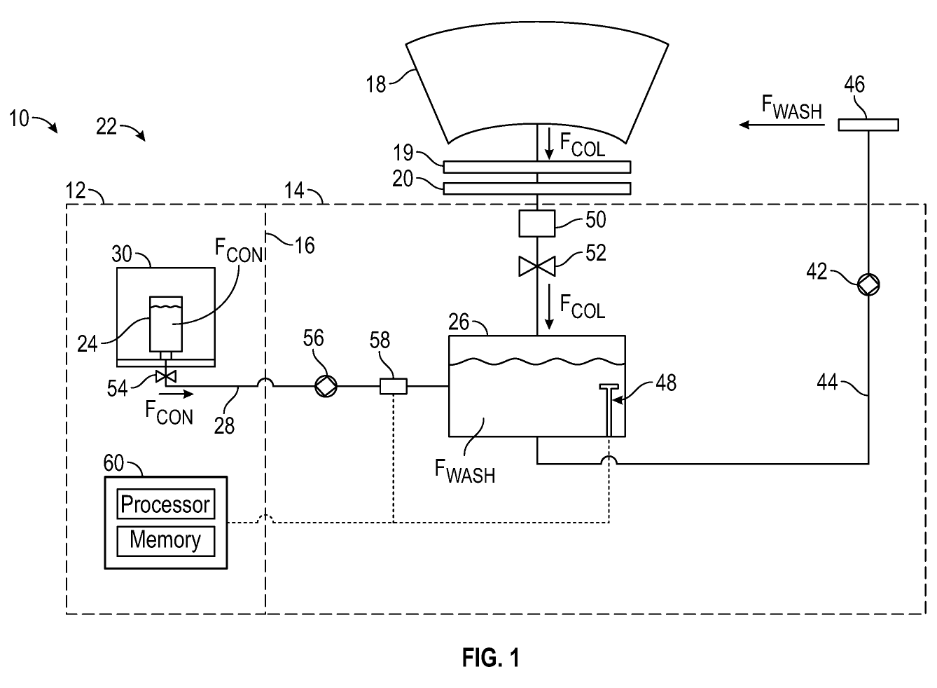

FIG. 1 schematically illustrates selected portions of a vehicle 10. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

The vehicle 10 includes a first compartment, here a passenger compartment 12, and a second compartment, here an engine compartment 14 (each shown in dashed lines for illustrative purposes). The passenger compartment 12 and the engine compartment 14 are separated by a barrier 16 (shown in dashed lines for illustrative purposes).

The passenger compartment 12 establishes a space for seating passengers within the vehicle 10. The passenger compartment 12 can include various accessible features for passengers, such as storage compartments, a user interface (UI) system, and charger ports for example.

The engine compartment 14 is generally forward the passenger compartment 12 and vertically beneath a windshield 18 of the vehicle 10. While the examples of this disclosure are described in connection with the engine compartment 14, the examples could be used in connection with other compartments of a vehicle, such as a frunk of an electric vehicle.

The engine compartment 14 establishes a space for housing components of the vehicle 10, such as an engine. The engine compartment 14 in this example, additionally houses components of an electrical system, such as a HVAC (Heating, Ventilation, and Air Conditioning) system, a battery, wiring harnesses, and various sensors for example.

As the vehicle 10 is operated, fluid can contact the windshield 18. Some of the fluid deposited on the windshield 18 may flow downward to a cowl 19 and a leaf screen 20. The cowl 19 interfaces with the windshield 18. The leaf screen 20 is vertically beneath the cowl 19. The leaf screen 20 could be integrated into the cowl 19 in other examples.

The cowl 19, in this example, is a muti-functional cowl that acts as an air intake for an HVAC system (not shown) of the vehicle 10 and manages fluid from the windshield 18. In an example, air from outside the vehicle 10 can enter through vents in the cowl 19, which directs the air into the HVAC system where the air can be heated, cooled, or otherwise circulated inside the vehicle 10.

Fluid from the windshield 18 can sometimes ingress into the engine compartment 14. In this example, the cowl 19 is configured to collect this fluid and direct the fluid toward specific discharge points on the vehicle 10. In this example, some of the fluid flows through the leaf screen 20, which acts as a barrier to prevent debris (e.g., leaves, twigs, etc.) from entering the engine compartment 14, and more particularly the HVAC system. As used herein, the “fluid” can include any fluid such as water, condensed water vapor, rain, used washer fluid, etc. that is deposited on the windshield 18.

A washer fluid management system 22 stores and uses fluid collected from the windshield 18 (hereafter “collected fluid F_{COL}”) to, in this example, provide a washer fluid F_{WASH} that can be used to clean the windshield 18. In some situations, adding the collected fluid F_{COL} to the washer fluid F_{WASH} may dilute the washer fluid F_{WASH}, thereby altering its effectiveness. The washer fluid management system 22 is configured to maintain a ratio of washer fluid F_{WASH} to prevent dilution. In this example, the ratio of washer fluid F_{WASH} maintained by the washer fluid management system 22 is effective to both clean the windshield 18 and prevent the washer fluid F_{WASH} from freezing in cold weather environments. Although the washer fluid F_{WASH} is described herein as being used to clean a windshield, the washer fluid F_{WASH} could be used to clean other components of the vehicle 10, including but not limited to, other windows, cameras, and sensors for example.

The exemplary washer fluid management system 22 includes a concentrate container 24, a washer fluid mixing tank 26, and a conduit 28 that fluidly couples the concentrate container 24 to the washer fluid mixing tank 26.

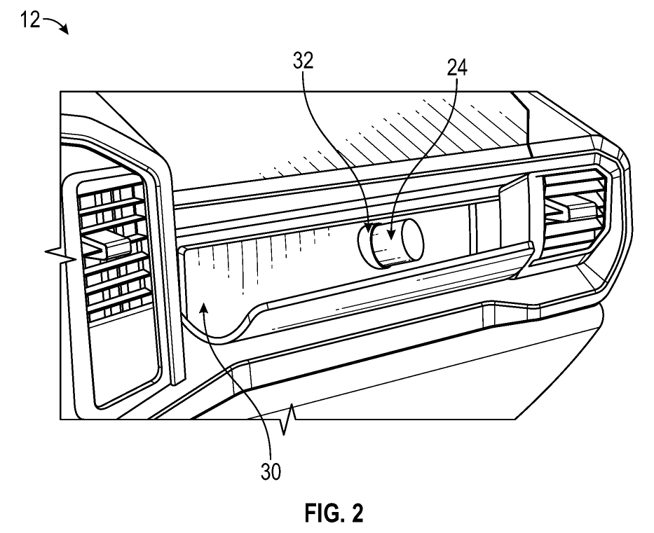

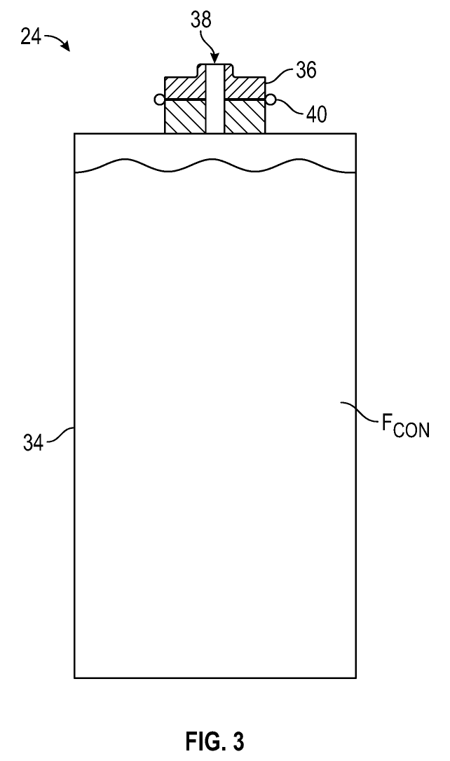

With further reference to FIGS. 2 and 3 and continuing reference to FIG. 1, the concentrate container 24 is supported within the passenger compartment 12. In this example, the concentrate container 24 is accessible from within a glovebox 30. The glovebox 30 establishes a space for storing items within the passenger compartment 12. A receptacle 32 is disposed in the glovebox 30 to receive the concentrate container 24.

In another example, the concentrate container 24 is disposed adjacent to a charger port within the passenger compartment 12. In other examples, the concentrate container 24 could be supported outside of the passenger compartment 12 and the engine compartment 14. For instance, the concentrate container 24 could be disposed adjacent to the leaf screen 20.

The concentrate container 24 includes a reservoir 34, a gasket 36, and a fluid passage 38, which is fluidly coupled to the conduit 28. The reservoir 34 is configured to hold a supply of washer concentrate fluid F_{CON}. The washer concentrate fluid F_{CON} can include a cleaning detergent, antifreeze, or any combination thereof.

The gasket 36 can be installed or otherwise secured to the receptacle 32 of the glovebox 30. In one example, the gasket 36 is inserted into the receptacle 32 and then twisted to lock the concentrate container 24 in place within the glovebox 30. The twisting and locking of the concentrate container 24 establishes a primary seal between the gasket 36 and the receptacle 32. Although the concentrate container 24 is described herein as being inserted via a twist-lock installation technique, the concentrate container 24 could be adapted to be installed using other installation techniques, including but not limited to, a push-lock mechanism and other quick-release coupling configurations for example.

The gasket 36 is configured to control a flow of washer concentrate fluid F_{CON} from the concentrate container 24 through the fluid passage 38. When the concentrate container 24 is not installed in the receptacle 32, the gasket 36 blocks the washer concentrate fluid F_{CON} from flowing out of the concentrate container 24 to prevent leakage of the washer concentrate fluid F_{CON}. When the concentrate container 24 is installed in the receptacle 32, the gasket 36 allows the washer concentrate fluid F_{CON} to flow to the conduit 28. It should be appreciated that the receptacle 32 could additionally or alternatively include features that control a flow of washer concentrate fluid F_{CON} from the concentrate container 24 through the fluid passage 38.

A seal (e.g., O-ring) 40 is positioned around an outer periphery of the gasket 36 to provide a secondary seal. The seal 40 enhances the sealing performance of the concentrate container 24 by providing additional barriers to leakage of the washer concentrate fluid F_{CON}.

The washer fluid mixing tank 26 is supported within the engine compartment 14. The washer fluid mixing tank 26 holds a supply of washer fluid F_{WASH}. The washer fluid F_{WASH} includes a mixture of the collected fluid F_{COL} and the washer concentrate fluid F_{CON} described above. A user can input a signal for a pump 42 to draw washer fluid F_{WASH} from the washer fluid mixing tank 26 through a line 44 that fluidly couples the washer fluid mixing tank 26 to at least one fluid spray nozzle 46. The fluid spray nozzle 46 is configured to spray washer fluid F_{WASH} onto the windshield 18 so that the windshield 18 can thereafter be cleaned by a pair of wipers (not shown).

The washer fluid mixing tank 26 includes a fluid level sensor 48 that measures an amount of washer fluid F_{WASH} within the washer fluid mixing tank 26.

The washer fluid mixing tank 26 is configured to receive a flow of the collected fluid F_{COL} from the windshield 18. The collected fluid F_{COL} is passed through a filter 50 and a valve (e.g., solenoid valve) 52 before it is received in the washer fluid mixing tank 26. The filter 50 is configured to remove particles and contaminants to improve the quality of the collected fluid F_{COL}. When closed, the valve 52 blocks the collected fluid F_{COL} from entering the washer fluid mixing tank 26, and when open, allows the collected fluid F_{COL} to enter the washer fluid mixing tank 26.

The conduit 28 fluidly couples the concentrate container 24 to the washer fluid mixing tank 26 such that washer concentrate fluid F_{CON} held in the concentrate container can flow to the washer fluid mixing tank 26. The conduit 28 is connected to a valve (e.g., solenoid valve) 54, a pump 56, and a flow sensor 58. When closed, the valve 54 blocks the washer concentrate fluid F_{CON} from flowing to the fluid mixing tank 26, and when open, allows the washer concentrate fluid F_{CON} to flow to the washer fluid mixing tank 26. The pump 56 drives the washer concentrate fluid F_{CON} into the washer fluid mixing tank 26. The flow sensor 58 measures an amount of washer concentrate fluid F_{CON} that flows to the washer fluid mixing tank 26 via the pump 56.

A control module 60 is communicatively coupled with the fluid level sensor 48 of the washer fluid mixing tank 26 and the flow sensor 58. The control module 60 may include both hardware and software and could be part of an overall vehicle control system, such as a vehicle system controller (VSC), or could alternatively be a stand-alone controller separate from the VSC. In an embodiment, the control module 60 is programmed with executable instructions for interfacing with and commanding operation of the washer fluid management system 22, and more particularly the valves 52, 54 and the pump 56.

The control module 60 may include a processor and non-transitory memory for executing various control strategies and modes associated with opening and closing the valves 52, 54 and activating the pump 56, as described above. The processor can be a custom made or commercially available processor, a central processing unit (CPU), or generally any device for executing software instructions. The memory can include any one or combination of volatile memory elements and/or nonvolatile memory elements.

The processor may be operably coupled to the memory and may be configured to execute one or more programs stored in the memory of the control module 60 based on a ratio of washer fluid F_{WASH} within the washer fluid mixing tank 26. The ratio of washer fluid F_{WASH} is determined by the amount of collected fluid F_{COL} and washer concentrate fluid F_{CON}. The ratio of washer fluid F_{WASH} is specifically formulated or otherwise effective to both clean the windshield 18 and prevent the washer fluid F_{WASH} from freezing in cold weather environments. In an embodiment, the ratio of washer fluid F_{WASH} is selected based on user preferences, weather, exterior temperatures, or any combination thereof.

The control module 60 may receive and process information indicative of changes to the ratio of washer fluid F_{WASH}. In an embodiment, the control module 60 closes the valve 52 to block the flow of collected fluid F_{COL} from entering the washer fluid mixing tank 26 in response to the fluid level sensor 48 determining that the amount of collected fluid F_{COL} within the washer fluid mixing tank 26 is above a predetermined threshold. The amount of collected fluid F_{COL} is the difference between the amount of washer fluid F_{WASH} before receiving the collected fluid F_{COL} and after receiving the collected fluid F_{COL}. The predetermined threshold is based on the amount of collected fluid F_{COL} that would alter the ratio of the washer fluid F_{COL} such that the concentration of washer concentrate fluid F_{CON} may be diluted. Dilution of the washer concentrate fluid F_{CON} may cause the washer fluid F_{WASH} to be less effective. By closing the valve 52 after determining that the predetermined threshold has been exceeded, the control module 60 ensures that the ratio of the washer fluid F_{WASH} is maintained.

In another embodiment, the control module 60 adjusts the amount of washer fluid concentrate F_{CON} that flows to the washer fluid mixing tank 26 based on the amount of collected fluid F_{COL} within the washer fluid mixing tank 26. If the amount of collected fluid F_{COL} exceeds the predetermined threshold, the control module 60 opens the valve 54 and activates the pump 56 to allow the washer fluid concentrate F_{CON} to enter the washer fluid mixing tank 26. The amount of washer fluid concentrate F_{CON} that enters the washer fluid mixing tank 26 is an amount sufficient to maintain the ratio of washer fluid F_{WASH}. This ensures that the ratio of washer fluid F_{WASH} is maintained even if the predetermined threshold is exceeded.

In another embodiment, the control module 60 closes the valve 52 in response to the concentrate container 24 being empty. The amount of washer concentrate fluid F_{CON} remaining in the concentrate container 24 can be determined based on how much the pump 56 has been activated and the amount of washer fluid concentrate F_{CON} that has been pumped through the conduit 28. Closing the valve 52 in this way ensures that the predetermined threshold is not exceeded when the concentrate container 24 is empty by blocking a flow of collected fluid F_{COL} from entering the fluid mixing tank 26.

In a further embodiment, the control module 60 can notify a user that the concentrate container 24 needs to be replaced. For instance, the control module 60 could display a message on the UI system of the vehicle 10 indicating that the concentrate container 24 is empty or an amount of washer concentrate fluid F_{CON} within the concentrate container 24 is below a predetermined threshold. Additionally or alternatively, the control module 60 could automatically order a replacement to the user’s home or chosen address.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle washer fluid management system, comprising:
a washer fluid mixing tank within a compartment of a vehicle;
a concentrate container that is outside the compartment, the concentrate container configured to hold a supply of washer concentrate fluid; and
a conduit that fluidly couples the concentrate container to the washer fluid mixing tank such that washer concentrate fluid held in the concentrate container can flow to the washer fluid mixing tank.

2. The vehicle washer fluid management system of claim 1, wherein the washer fluid mixing tank is configured to receive a flow of collected fluid from a windshield of the vehicle.

3. The vehicle washer fluid management system of claim 2, further comprising a fluid level sensor that measures an amount of collected fluid within the washer fluid mixing tank.

4. The vehicle washer fluid management system of claim 3, further comprising a valve between the windshield and the washer fluid mixing tank, the valve configured to block the flow of collected fluid from the windshield in response to the fluid level sensor determining that the amount of collected fluid within the washer fluid mixing tank is above a predetermined threshold.

5. The vehicle washer fluid management system of claim 4, wherein the valve is configured to block the flow of collected fluid from the windshield when the concentrate container is empty.

6. The vehicle washer fluid management system of claim 3, wherein an amount of washer concentrate fluid that flows to the washer fluid mixing tank is adjusted based on the amount of collected fluid received within the washer fluid mixing tank.

7. The vehicle washer fluid management system of claim 2, further comprising a filter configured to filter the flow of collected fluid from the windshield before the collected fluid is received within the washer fluid mixing tank.

8. The vehicle washer fluid management system of claim 1, further comprising a flow sensor connected to the conduit and configured to measure an amount of washer concentrate fluid that flows to the washer fluid mixing tank.

9. The vehicle washer fluid management system of claim 1, wherein the compartment is an engine compartment.

10. The vehicle washer fluid management system of claim 1, wherein the concentrate container is within a passenger compartment of the vehicle.

11. The vehicle washer fluid management system of claim 10, wherein the concentrate container is accessible from within a glovebox.

12. The vehicle washer fluid management system of claim 10, wherein the concentrate container is disposed adjacent to a charger port.

13. The vehicle washer fluid management system of claim 1, wherein the concentrate container is disposed adjacent to a leaf screen of the vehicle.

14. A vehicle washer fluid management method, comprising:
receiving collected fluid in a washer fluid mixing tank within a compartment of a vehicle; and
directing washer concentrate fluid from a concentrate container that is outside of the compartment to the washer fluid mixing tank to allow the collected fluid and the washer concentrate fluid to mix within the washer fluid mixing tank, the concentrate container fluidly coupled to the washer fluid mixing tank through a conduit.

15. The method of claim 14, wherein the collected fluid is collected from a windshield of the vehicle.

16. The method of claim 14, further comprising measuring an amount of collected fluid received within the washer fluid mixing tank before directing the washer concentrate fluid to the washer fluid mixing tank.

17. The method of claim 16, further comprising blocking the collected fluid from being received in the washer fluid mixing tank in response to determining that the amount of collected fluid within the washer fluid mixing tank is above a predetermined threshold.

18. The method of claim 16, further comprising blocking the collected fluid from being received in the washer fluid mixing tank in response to determining that the concentrate container is empty.

19. The method of claim 16, further comprising adjusting an amount of washer concentrate fluid that is directed into the washer fluid mixing tank based on the amount of collected fluid received within the washer fluid mixing tank.

20. The method of claim 19, wherein a ratio of collected fluid and washer concentrate fluid within the washer fluid mixing tank is controlled by a user, weather, exterior temperatures, or any combination thereof.
